(19) United States
(12) Patent Application Publication
(10) Pub. No.: US 2021/0042713 A1
(43) Pub. Date: Feb. 11, 2021

(54) INTELLIGENT ATTRIBUTE SPATIAL SCANNING SYSTEM

(71) Applicant: BANK OF AMERICA CORPORATION, Charlotte, NC (US)

(72) Inventor: Prasad Balkrishna Bag, Mumbai (IN)

(73) Assignee: BANK OF AMERICA CORPORATION, Charlotte, NC (US)

(21) Appl. No.: 16/531,336

(22) Filed: Aug. 5, 2019

(51) Int. Cl. G06Q 20/04; G06N 20/00; G06K 9/00; G06K 9/62; G06K 9/72

(52) U.S. Cl. CPC G06Q 20/042; G06N 20/00; G06K 2209/01; G06K 9/6202; G06K 9/72; G06K 9/00469

(57) ABSTRACT

Embodiments of the invention include systems, methods, and computer-program products for real-time intelligent attribute spatial scanning of resource distribution instruments received for processing. The invention provides an image read program that divides a received resource distribution instrument into different sections and reads the various attributes in each section. The invention scans the spatial areas between the attributes and measures the distances between those attributes. As such, identifying actual position within the resource distribution instrument, establishing a symmetry in the resource distribution instrument image. The symmetry data is processed to cluster out areas in the resource distribution instrument that are suspicious based on the symmetry evaluation, to prevent processing of a misappropriated resource distribution instrument in real-time.

### BACKGROUND

Entities typically receive large volumes of documents from vendors, customers, or employees on any given day. Misappropriated documents appear very similar to legitimate documents and may be processed as such. Eventually, downstream, the misappropriated document may be identified and rejected. However, at that time resources and other actions may have been translated based on the document. As such, a system may be necessary to examine characteristics of the document for processing.

### BRIEF SUMMARY

Embodiments of the present invention address the above needs and/or achieve other advantages by providing apparatuses (e.g., a system, computer program product, and/or other devices) and methods for an intelligent attribute spatial scanning system.

In some embodiments, the system may receive images of resource distribution instruments or negotiable instruments from one or more sources. The resource distribution instruments may be received from within an entity, from other financial institutions, or the like. In some instances these resource distribution instruments may be misappropriated resource distribution instruments. The misappropriated resource distribution instruments may appear almost the same as legitimate resource distribution instruments and typically successfully pass through initial resource distribution instrument processing. Once the misappropriated resource distribution instrument is initially processed, the resource amount associated with the instrument is credited in the user's account. However, eventually in the processing the misappropriated resource distribution instrument gets identified as misappropriated, then the credited amount of resources must be removed from the user's account. Not being able to identify this misappropriation causes delay, unnecessary resource distributions, and entity loss of revenue.

In some embodiments, the invention provides an image read program that divides a received resource distribution instrument into different sections and reads the various attributes like date, pay to the order of, resource distribution instrument number, security icon, amount, and the like and the attributes actual position within the resource distribution instrument. The system may read these attributes and the relative position of these attributes to establish a symmetry in the resource distribution instrument image. The symmetry data is processed via machine learning algorithms to cluster out areas in the resource distribution instrument that are suspicious based on the symmetry evaluation. The system may continue to process the data and provide results to prevent the processing of the misappropriated resource distribution instrument prior to distribution.

Embodiments of the invention relate to systems, methods, and computer program products for receiving an image of a resource distribution instrument; identifying and dividing segments of the image of the resource distribution instrument, wherein the segments are divided by attributes on the resource distribution instrument; programming resource distribution instrument attribute data for comparison analysis; performing comparison analysis via machine learning application processing, wherein the comparison analysis compares a symmetry of the resource distribution instrument attributes to a resource distribution instrument standard; flagging resource distribution instrument comprising a symmetrical anomaly; routing the resource distribution instrument for exception processing within flagged information associated with the resource distribution instrument; and providing a feedback loop to the machine learning application for result identification of all resource distribution instruments.

In some embodiments, the invention further comprises allowing for real-time resource transfer upon indication on an authentic resource distribution instrument upon a symmetry match between the resource distribution instrument and the resource distribution instrument standard.

In some embodiments, performing comparison analysis further comprises identifying locations of the attributes compared to a standard via an overlay, wherein the locations of the attributes and a distance between the attributes is compared.

Ins some embodiments, the resource distribution instrument standard further comprises a standard for a location for each attribute and a standard distance between each attribute. In some embodiments, the attributes of the resource distribution instrument further comprises elements on the resource distribution instruments that are physically printed on the resource distribution instrument.

In some embodiments, receiving an image of a resource distribution instrument further comprising performing optical character recognition on a physical resource distribution instrument to generate the image of the resource distribution instrument. In some embodiments, the resource distribution instrument comprises a check for a transfer of resources from one user to a second user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an intelligent attribute spatial scanning system environment, in accordance with one embodiment of the present invention;

FIG. 2A provides a high level process flow illustrating intelligent attribute spatial scanning, in accordance with one embodiment of the present invention;

FIG. 2B provides a high level process flow illustrating setting up an intelligent attribute spatial scanning system, in accordance with one embodiment of the present invention;

FIG. 3 provides a high level process flow illustrating processing a resource distribution instrument via the intelligent attribute spatial scanning system, in accordance with one embodiment of the present invention;

FIG. 4 provides a high level process flow illustrating decisioning across the intelligent attribute spatial scanning process, in accordance with one embodiment of the present invention;

FIG. 5A illustrates an exemplary image of a resource distribution instrument, in accordance with one embodiment of the present invention;

FIG. 5B illustrates an exemplary image of a processed resource distribution instrument, in accordance with one embodiment of the present invention;

FIG. 6A provides an exemplary image of an alternative resource distribution instrument, in accordance with one embodiment of the present invention; and

FIG. 6B provides an exemplary image of a processed alternative resource distribution instrument, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. As used herein, a “document,” “resource distribution instrument,” “financial document,” “financial record,” or “payment instrument” may also refer to a myriad of resource distribution instrument documents, including but not limited to a check. Furthermore, the resource distribution instrument could include a deposit slip, a payment coupon, a receipt, general ledger tickets, or the like. In some embodiments, “document”, “financial record”, or “resource distribution instrument” may exist as a physical item printed on paper or other medium. In other embodiments, the resource distribution instrument may exist electronically. Furthermore, “document,” “financial document,” “financial record,” “payment instrument,” or “resource distribution instrument” may also refer to records associated with government data, legal data, identification data, and the like. The data of the financial records or non-financial records may be provided in a wide variety formats including, paper records, electronic or digital records, video records, audio records, and/or combinations thereof. In some embodiments, the “document,” “financial record,” or “resource distribution instrument” may be referred to in examples as a resource distribution instrument or the like. Furthermore, the term “image lift data” or “data lift” may refer to the process of lifting one or more areas/elements of a document and storing those areas as metadata without storing the entire document as an image file.

In some embodiments, the system may receive images of resource distribution instruments or negotiable instruments from one or more sources. The resource distribution instruments may be received from within an entity, from other financial institutions, or the like. In some instances these resource distribution instruments may be misappropriated resource distribution instruments. The misappropriated resource distribution instruments may appear almost the same as legitimate resource distribution instruments and typically successfully pass through initial resource distribution instrument processing. Once the misappropriated resource distribution instrument is initially processed, the resource amount associated with the instrument is credited in the user's account. However, eventually in the processing the misappropriated resource distribution instrument gets identified as misappropriated, then the credited amount of resources must be removed from the user's account. Not being able to identify this misappropriation causes delay, unnecessary resource distributions, and entity loss of revenue.

In some embodiments, the invention provides an image read program that divides a received resource distribution instrument into different sections and reads the various attributes like date, pay to the order of, resource distribution instrument number, security icon, amount, and the like and the attributes actual position within the resource distribution instrument. The system may read these attributes and the relative position of these attributes to establish a symmetry in the resource distribution instrument image. The symmetry data is processed via machine learning algorithms to cluster out areas in the resource distribution instrument that are suspicious based on the symmetry evaluation. The system may continue to process the data and provide results to prevent the processing of the misappropriated resource distribution instrument prior to distribution.

In some embodiments, the system leverages capability of machine learning networks to perform predictive analytics to suspicious potentially misappropriated resource distribution instruments to confirm spatial attributes within a resource distribution instrument for confirmation of authentication. The system, via an image read program, may receive a resource distribution instrument image. The system may read the various printed attributes on the resource distribution instrument image and identify the attributes position on the image. The attribute data associated with the attribute locations is processed via a predictive analytic model as a input. The processing provides analytic results of the attribute locations compared to ANSI standards.

In some embodiments, the analysis may produce results identifying if the resource distribution instrument image needs clarity, such that the system may not be able to identify the attributes based on the image clarity. In some embodiments, the analysis may produce results identifying the symmetry of the attributes being off from the standard attribute symmetry, as such providing an indication of a misappropriated resource distribution instrument. In some embodiments, the analysis may provide trend or correlation data between different variables to be included in a feedback loop to provide to the system for subsequent resource distribution instrument image reviewing.

In some embodiments, if a suspicious resource distribution instrument is identified as possibly being a misappropriated resource distribution instrument, the areas or attributes in the image that are not in the correct location are highlighted and flagged. The resource distribution instrument image, along with the highlighted locations are routed for exception processing.

Based on the results of the exception processing, the system provides a feedback loop for developing decisions on subsequent resource distribution instrument image processing. As such, allowing for maximum misappropriation detection at initial review. Furthermore, if resource distribution instruments are identified as authentic by the system and later are detected as misappropriated resource distribution instruments. The feedback loop may provide analysis as to why the resource distribution instrument passed the processing and updated the model to catch these misappropriated resource distribution instrument in the future.

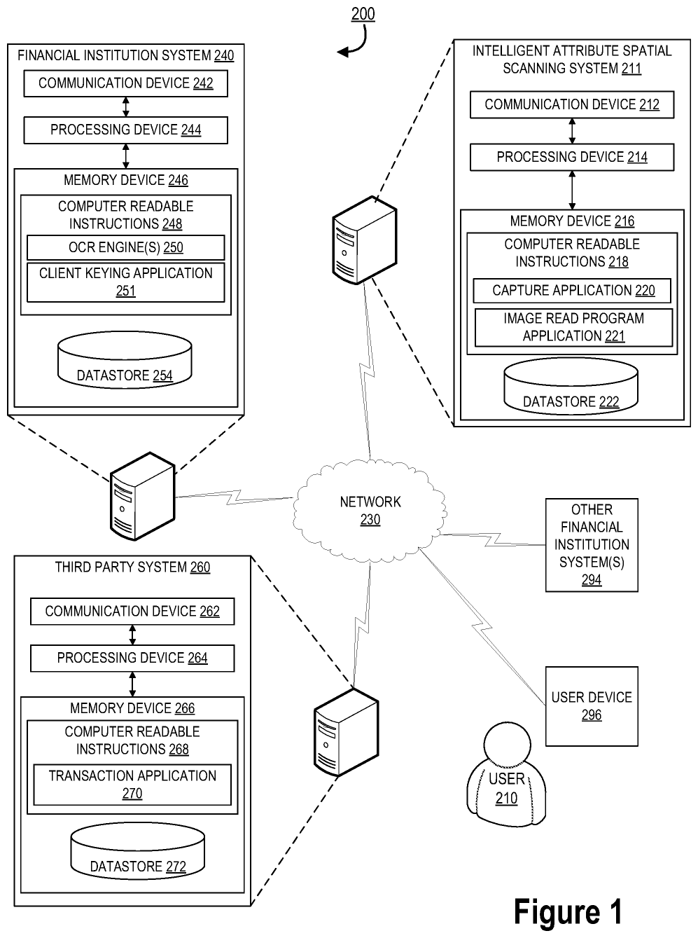

FIG. 1 illustrates an intelligent attribute spatial scanning system environment 200, in accordance with some embodiments of the invention. The environment 200 includes an intelligent attribute spatial scanning system 211, a third party system 260, and a financial institution system 240. In some embodiments, the third party system 260 corresponds to a third party financial institution. The environment 200 further includes one or more third party systems (e.g., a partner, agent, or contractor associated with a financial institution), one or more other financial institution systems 294 (e.g., a credit bureau, third party banks, and so forth), and one or more user devices 296 associated with a user depositing or receiving resources from a resource distribution instrument.

The systems and devices communicate with one another over the network 230 and perform one or more of the various steps and/or methods according to embodiments of the disclosure discussed herein. The network 230 may include a local area network (LAN), a wide area network (WAN), and/or a global area network (GAN). The network 230 may provide for wireline, wireless, or a combination of wireline and wireless communication between devices in the network. In one embodiment, the network 230 includes the Internet.

The intelligent attribute spatial scanning system 211, the third party system 260, and the financial institution system 240 each includes a computer system, server, multiple computer systems and/or servers or the like. The financial institution system 240, in the embodiments shown has a communication device 242 communicably coupled with a processing device 244, which is also communicably coupled with a memory device 246. The processing device 244 is configured to control the communication device 242 such that the financial institution system 240 communicates across the network 230 with one or more other systems. The processing device 244 is also configured to access the memory device 246 in order to read the computer readable instructions 248, which in some embodiments includes a one or more OCR engine applications 250 and a client keying application 251. The memory device 246 also includes a datastore 254 or database for storing pieces of data that can be accessed by the processing device 244. In some embodiments, the datastore 254 includes a resource distribution instrument data repository.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 214, 244, or 264 may further include functionality to operate one or more software programs based on computer-executable program code thereof, which may be stored in a memory. As the phrase is used herein, a processing device 214, 244, or 264 may be “configured to” perform a certain function in a variety of ways, including, for example, by having one or more general-purpose circuits perform the function by executing particular computer-executable program code embodied in computer-readable medium, and/or by having one or more application-specific circuits perform the function.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory device 246 includes any computer memory that provides an actual or virtual space to temporarily or permanently store data and/or commands provided to the processing device 244 when it carries out its functions described herein.

The intelligent attribute spatial scanning system 211 includes a communication device 212 communicably coupled with a processing device 214, which is also communicably coupled with a memory device 216. The processing device 214 is configured to control the communication device 212 such that the intelligent attribute spatial scanning system 211 communicates across the network 230 with one or more other systems. The processing device 214 is also configured to access the memory device 216 in order to read the computer readable instructions 218, which in some embodiments includes a capture application 220 and an image read program application 221. The memory device 216 also includes a datastore 222 or database for storing pieces of data that can be accessed by the processing device 214.

The third party system 260 includes a communication device 262 and an image capture device (not shown) communicably coupled with a processing device 264, which is also communicably coupled with a memory device 266. The processing device 264 is configured to control the communication device 262 such that the third party system 260 communicates across the network 230 with one or more other systems. The processing device 264 is also configured to access the memory device 266 in order to read the computer readable instructions 268, which in some embodiments includes a transaction application 270. The memory device 266 also includes a datastore 272 or database for storing pieces of data that can be accessed by the processing device 264.

In some embodiments, the capture application 220, the image read program application 221, and the transaction application 270 interact with the OCR engines 250 to receive or provide financial record images and data, detect and extract financial record data from financial record images, analyze financial record data, and implement business strategies, transactions, and processes. The OCR engines 250 and the client keying application 251 may be a suite of applications for conducting OCR.

In some embodiments, the capture application 220, the image read program application 221, and the transaction application 270 interact with the OCR engines 250 to utilize the extracted metadata to determine decisions for exception processing. In this way, the system may systematically resolve exceptions.

In some embodiments, the capture application 220, the image read program application 221, and the transaction application 270 interact with the OCR engines 250 to identify suspect items within the attributes. The document or resource distribution instrument processing may be stopped because of this identification. In some embodiments, the suspect items may be detected utilizing OCR based on data received from a customer external to the document in comparison to the document. In some embodiments, the suspect items may be detected utilizing OCR based on data associated with the account in comparison to the document.

The applications 220, 221, 250, 251, and 270 are for instructing the processing devices 214, 244 and 264 to perform various steps of the methods discussed herein, and/or other steps and/or similar steps. In various embodiments, one or more of the applications 220, 221, 250, 251, and 270 are included in the computer readable instructions stored in a memory device of one or more systems or devices other than the systems 260 and 240 and the intelligent attribute spatial scanning system 211. For example, in some embodiments, the application 220 is stored and configured for being accessed by a processing device of one or more third party systems connected to the network 230. In various embodiments, the applications 220, 221, 250, 251, and 270 stored and executed by different systems/devices are different. In some embodiments, the applications 220, 221, 250, 251, and 270 stored and executed by different systems may be similar and may be configured to communicate with one another, and in some embodiments, the applications 220, 221, 250, 251, and 270 may be considered to be working together as a singular application despite being stored and executed on different systems.

In various embodiments, one of the systems discussed above, such as the financial institution system 240, is more than one system and the various components of the system are not collocated, and in various embodiments, there are multiple components performing the functions indicated herein as a single device. For example, in one embodiment, multiple processing devices perform the functions of the processing device 244 of the financial institution system 240 described herein. In various embodiments, the financial institution system 240 includes one or more of the user devices 296 and/or any other system or component used in conjunction with or to perform any of the method steps discussed herein. For example, the financial institution system 240 may include a financial institution system, a credit agency system, and the like.

In various embodiments, the financial institution system 240, the third party system 260, and the intelligent attribute spatial scanning system 211 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 300, the other methods discussed below, or other methods, processes or steps discussed herein or not discussed herein.

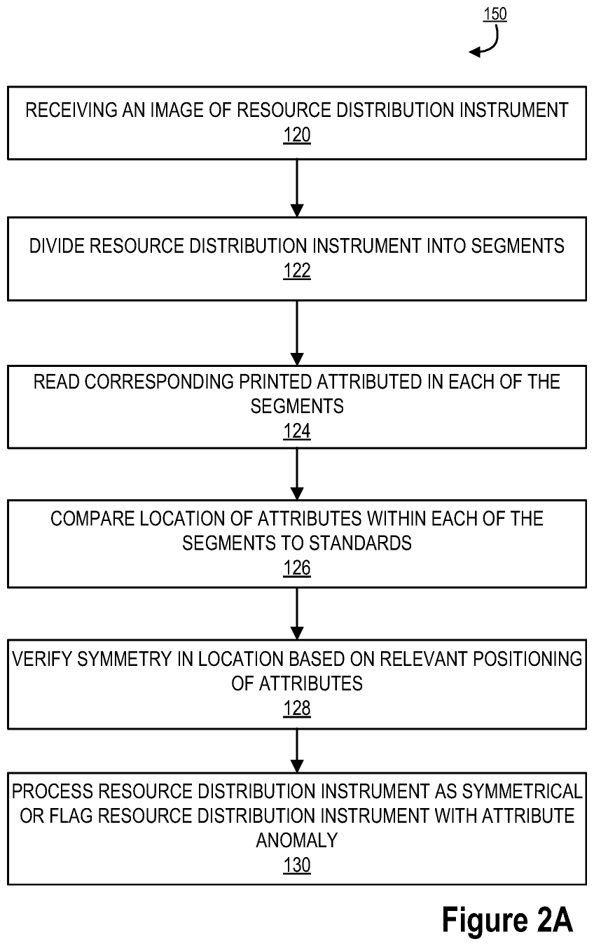

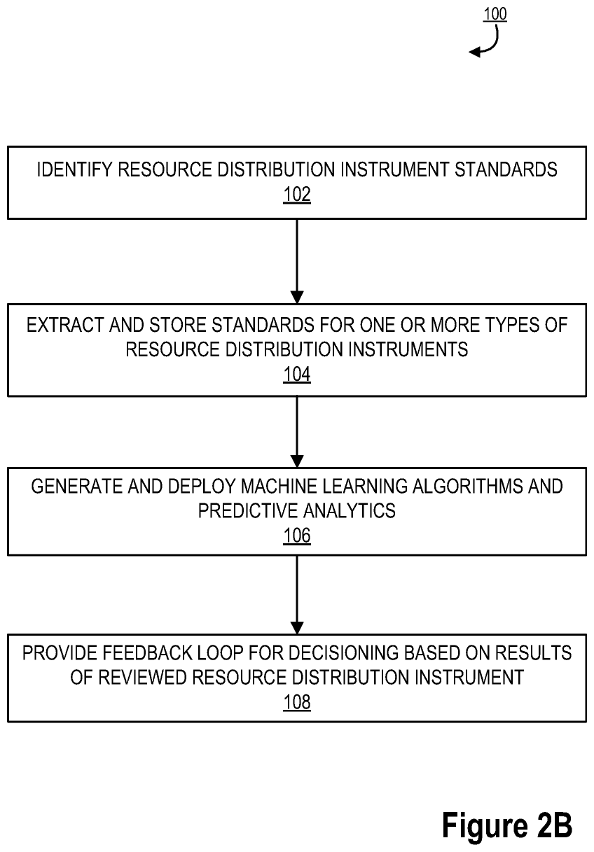

FIG. 2A provides a high level process flow illustrating intelligent attribute spatial scanning 150, in accordance with one embodiment of the present invention. As illustrated in block 120, the method comprises receiving an image of a resource distribution instrument or other resource distribution instrument. The image received may be one or more of a resource distribution instrument, other document, payment instrument, and/or financial record. In some embodiments, the image of the resource distribution instrument may be received by a specialized apparatus associated with the financial institution (e.g. a computer system) via a communicable link to a user's mobile device, a camera, an Automated Teller Machine (ATM) at one of the entity's facilities, a second apparatus at a teller's station, another financial institution, or the like. In other embodiments, the apparatus may be specially configured to capture the image of the resource distribution instrument for storage and exception processing.

As illustrated in block 122, the system divide the resource distribution instrument into segments comprising attributes. As such, the system may perform initial processing of the resource distribution instrument. In this way, the system may receive the resource distribution instrument, confirm authenticity, and then lift indicia in the form of data off of the resource distribution instrument using optical character recognition (OCR). The OCR processes enables the system to convert text and other symbols in the resource distribution instrument images to other formats such as text files and/or metadata, which can then be used and incorporated into a variety of applications, documents, and processes. In some embodiments, OCR based algorithms used in the OCR processes incorporate pattern matching techniques. For example, each character in an imaged word, phrase, code, or string of alphanumeric text can be evaluated on a pixel-by-pixel basis and matched to a stored character. Various algorithms may be repeatedly applied to determine the best match between the image and stored characters.

Furthermore the resource distribution instrument may be divided into segments. Each segment may contain an attribute, such as date, pay to the order of, check number, security icon, amount, and the like.

The system defines location fields of the resource distribution instrument segments by separating the elements of the image of the resource distribution instrument into segments. As referred to herein, the term segment is used broadly to describe the process of differentiating elements of a resource distribution instrument image by separating portions and/or elements of the image of the resource distribution instrument into sectors in order to define the location fields. These sectors may be identified using a two-dimensional coordinate system or any other system that can be used for determining the location of the sectors. In many instances, each sector will be rectangular in shape. In some embodiments, the system identifies each portion of the image of the resource distribution instrument using a plurality of segments. In such an embodiment, the system may further analyze each segment using the OCR algorithms in order to determine whether each segment has valuable or useful information. Generally, valuable or useful information may relate to any data or information that may be used for processing and/or settlement of the resource distribution instrument, used for identifying the resource distribution instrument, and the like.

Next, as illustrated in block 124, the process 150 continues by reading the corresponding attributes in each segment. The attributes may be one or more portions of a check. These may include address, check number, date, pay to the order of, signature, memo, bank information, or the like.

As illustrated in block 126, the process 150 continues by comparing the location of the attributes within each of the segments to ANSI standards. The ANSI standards are specific locations each attribute is supposed to be within a resource distribution instrument. As such, each attribute should be located within a specific location on an instrument to be considered an authentic instrument. As illustrated in block 128, the system may verify symmetry in locations based on relevant positioning of the attributes compared to the standards. Furthermore, upon comparison the process 150 may allow for processing of the resource distribution instruments as symmetrical or flag the resource distribution instrument as an attribute anomaly and as being a potentially misappropriated instrument.

FIG. 2B provides a high level process flow illustrating setting up an intelligent attribute spatial scanning system 100, in accordance with one embodiment of the present invention. As illustrated in block 102, the process 100 is initiated by identifying resource distribution instrument standards. The standards provide for specific locations of attributes for any authentic resource distribution instrument. The standards provide for locations of attributes relative to each other on a resource distribution instrument. An authentic resource distribution instrument will confirm to the standards and have each attribute being the correct size and the correct spacing relative to each other.

Next, as illustrated in block 104, the process 100 continues by extracting and storing the standards for each type of the one or more types of resource distribution instrument. In this way, the system may store the standards for comparison of the standards to the received resource distribution instrument in real-time for confirmation of resource distribution instrument authentication. As illustrated in block 106, using the standards, the system may generate and deploy machine learning algorithms and predictive analytics for resource distribution instrument authentication determination. Using the machine learning algorithms and predictive analytics, the system can quickly scan the received resource distribution instrument and compare the received resource distribution instrument to the standards.

Finally, as illustrated in block 108, the process 100 is completed by providing a feedback loop for decisioning based on results of reviewed resource distribution instruments. In this way, after a resource distribution instrument has been scanned by the system, the resource distribution instrument may continue to be processed. If it is determined in later processing that the resource distribution instrument is misappropriated, the system may provide that feedback back to the system for digestion into the machine learning and predictive analytics for subsequent resource distribution instrument reviewing.

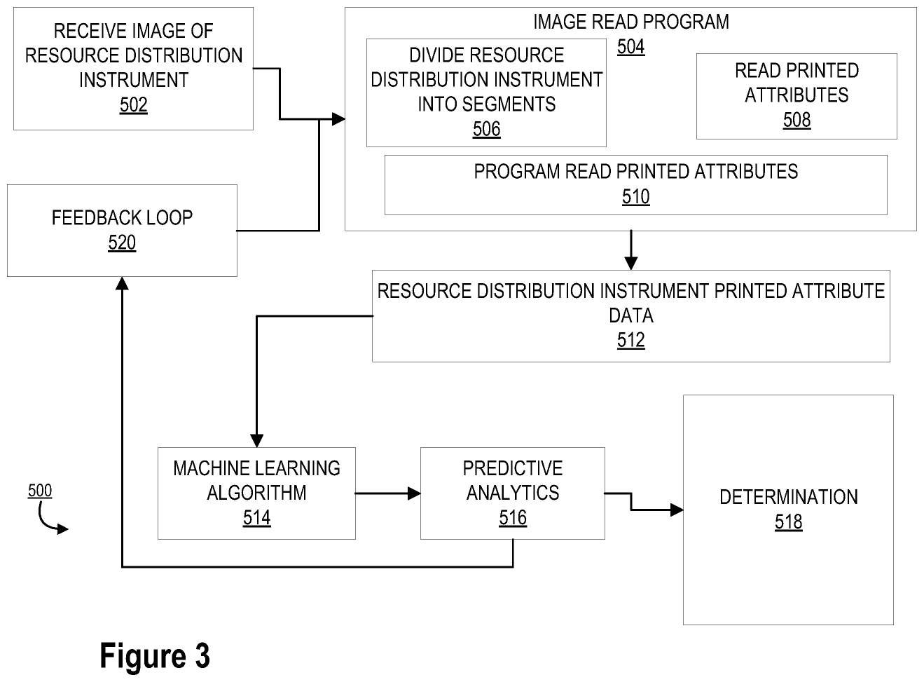

FIG. 3 provides a high level process flow illustrating processing a resource distribution instrument via the intelligent attribute spatial scanning system 500, in accordance with one embodiment of the present invention. As illustrated in block 502, the process 500 is initiated by receiving an image of a resource distribution instrument. The image of the resource distribution instrument may be received from a user and be an initial receiving of the resource distribution instrument for processing. The resource distribution instrument may be a document for the transferring of resources from one party to another. The resource distribution instrument may, for example, be a personal check.

Once the resource distribution instrument is imaged and received, the system, via the image read program 504 application may perform operations on the resource distribution instrument. First, the image read program 504 may divide the resource distribution instrument into segments, as illustrated in block 506. The segments may each comprise an attribute of the resource distribution instrument. As described, attributes may be elements of the resource distribution instrument such as date, pay to the order of, MICR line, signature, memo, check number, bank address, user address, security code, and the like. Along with dividing the resource distribution instrument into segments, the image read program 504 application may also read the printed attributes within each of those section, as illustrated in block 508. In this way, the system identifies the resource distribution instrument attributes and their actual position relative to each other. Identifying the actual position of the attributes relative to each other may be performed by the program read of the printed attributes, as illustrated in block 510.

As illustrated in block 512, the process 500 continues by processing the resource distribution instrument printed attribute data and packaging the data for transmission to the machine learning algorithm. As illustrated in block 514, the process 500 continues by processing the resource distribution instrument printed attribute data within a machine learning algorithm network via deep neural network with an input, hidden processing, and an output. Next, as illustrated in block 516, the system continues processing the attribute data via predictive analytics for further processing of the resource distribution instrument image for identification of misappropriate or authentic resource distribution instruments. The analytics may also determine if any misappropriated resource distribution instruments were missed. The missed misappropriated resource distribution instruments may be identified by down stream processing. Upon identification of the missed misappropriated resource distribution instruments, the system may provide a feedback loop 520, to subsequently amend the machine learning algorithms to catch any future misappropriated resource distribution instruments being processed by the system.

Finally, as illustrated in block 518, the process 500 is completed by making a determination on the authentication of the resource distribution instrument in real-time for instant processing of the resource distribution instrument for resource distribution.

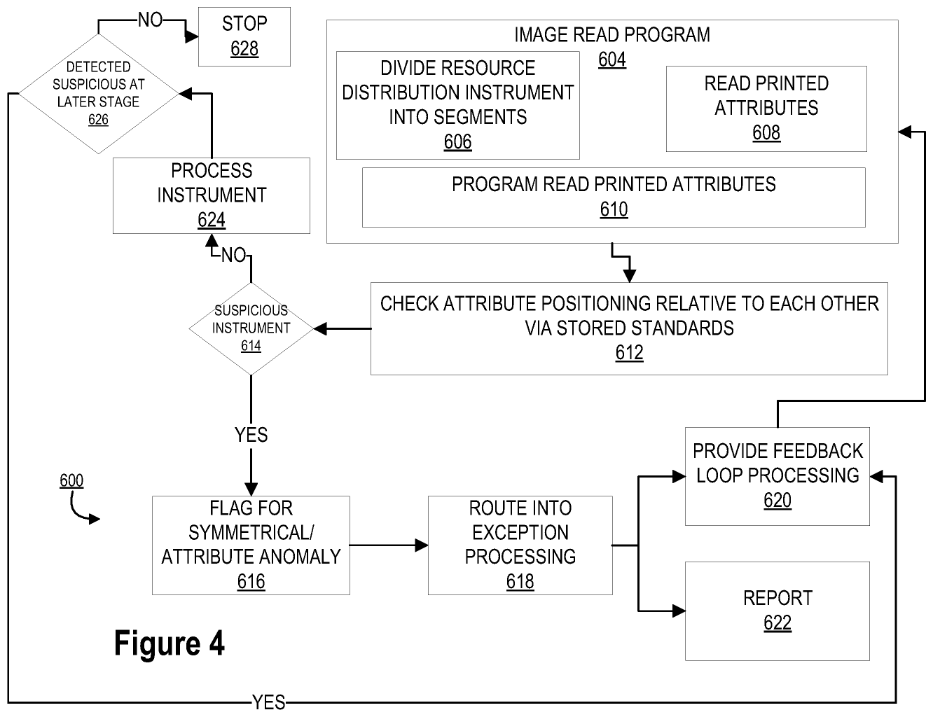

FIG. 4 provides a high level process flow illustrating decisioning across the intelligent attribute spatial scanning process 600, in accordance with one embodiment of the present invention. Once the resource distribution instrument is imaged and received, the system, via the image read program 604 application may perform operations on the resource distribution instrument. First, the image read program 604 may divide the resource distribution instrument into segments, as illustrated in block 606. The segments may each comprise an attribute of the resource distribution instrument. As described, attributes may be elements of the resource distribution instrument such as date, pay to the order of, MICR line, signature, memo, check number, bank address, user address, security code, and the like. Along with dividing the resource distribution instrument into segments, the image read program 604 application may also read the printed attributes within each of those section, as illustrated in block 608. In this way, the system identifies the resource distribution instrument attributes and their actual position relative to each other. Identifying the actual position of the attributes relative to each other may be performed by the program read of the printed attributes, as illustrated in block 610.

As illustrated in block 612, the process 600 continues by checking the attribute positioning relative to each other as compared to the stored standards. As such, the system may be able to overlay standards over the image of the resource distribution instrument to confirm exact location specifications for the resource distribution instrument attributes. The comparison may compare the distances between attributes, the location of each attribute on the resource distribution instrument, and the like relative to the standard data stored.

Next, as illustrated in block 614, the system determines if the resource distribution instrument is a suspicious document. If it is determined not to be a suspicious document based on the comparison, the resource distribution instrument may continue to be processed for resource distribution, as illustrated in block 624. The resource distribution instrument may be continued to be processed downstream. As illustrated in block 626, the system determines if the resource distribution instrument was determined to be suspicious at a later stage in the processing. If not, then the process 600 is completed, as illustrated in block 628. If the resource distribution instrument is detected to be suspicious at a later stage, that data is then provided back to the system via the feedback loop, as illustrated in block 620.

Referring back to block 614, if the resource distribution instrument is determined to be suspicious based on a comparison of the resource distribution instrument attribute positions relative to the standard, the system may flag the resource distribution instrument for symmetrical/attribute anomaly, as illustrated in block 616. The flagged resource distribution instrument may be processed as an anomaly and not allow for the transmission of resources via the resource distribution instrument until cleared.

As illustrated in block 618, the process 600 continues by routing the resource distribution instrument into the exception processing. In this way, the resource distribution instrument may be initially routed into the exception processing to further identify the resource distribution instrument as a non-authentic resource distribution instrument. As illustrated in block 622, the system may receive a report of the final outcome of the exception processing. As illustrated in block 620, the system provides a feedback loop processing for the machine learning algorithms to constantly update and learn.

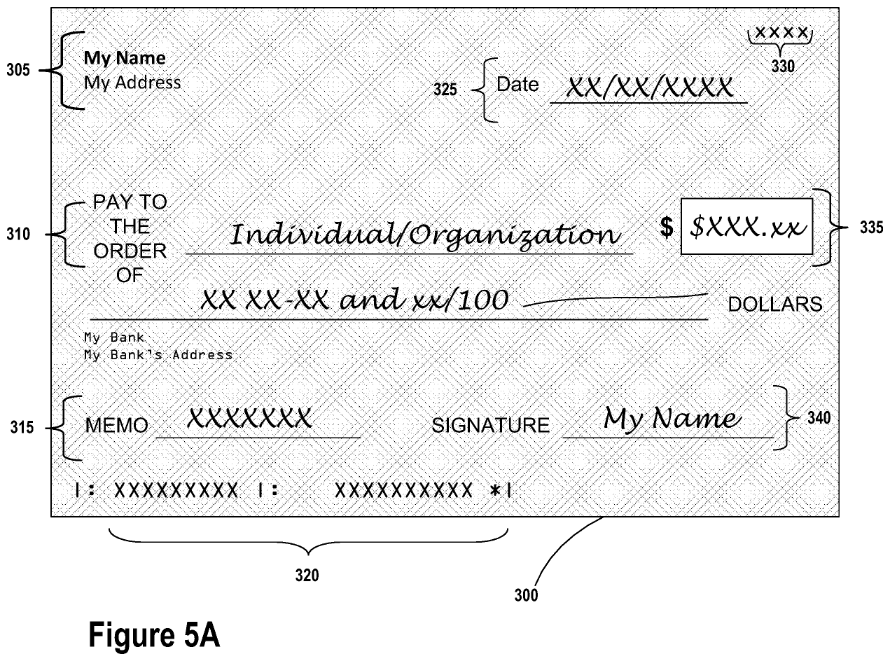

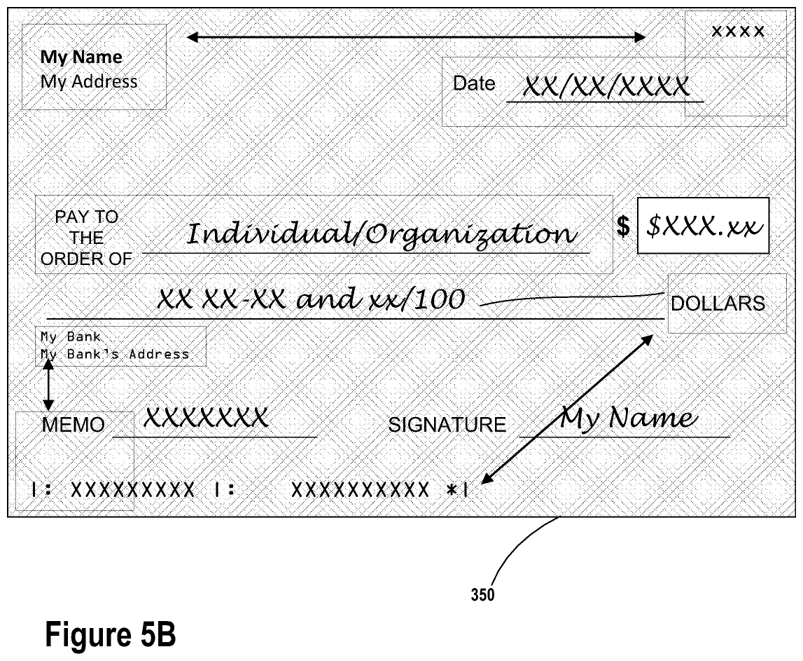

FIG. 5A provides an illustration of an exemplary image of a resource distribution instrument 300, in accordance with one embodiment of the present invention. The resource distribution instrument illustrated in FIG. 5A is a check. However, one will appreciate that any financial record, financial document, payment instrument, or the like may be provided.

The image of resource distribution instrument 300 may comprise an image of the entire resource distribution instrument, a thumbnail version of the image of the resource distribution instrument, individual pieces of resource distribution instrument information, all or some portion of the front of the resource distribution instrument, all or some portion of the back of the resource distribution instrument, or the like. Resource distribution instrument 300 comprises resource distribution instrument information, wherein the resource distribution instrument information comprises contact information 305, the payee 310, the memo description 315, the account number and routing number 320 associated with the appropriate user or customer account, the date 325, the resource distribution instrument number 330, the amount of the resource distribution instrument 335, the signature 340, or the like. In some embodiments, the resource distribution instrument information may comprise text. In other embodiments, the resource distribution instrument information may comprise an image. A capture device may capture an image of the resource distribution instrument 300 and transmit the image to a system of a financial institution via a network. The system may collect the resource distribution instrument information from the image of the resource distribution instrument 300 and store the resource distribution instrument information in a datastore as metadata. In some embodiments, the pieces of resource distribution instrument information may be stored in the datastore individually. In other embodiments, multiple pieces of resource distribution instrument information may be stored in the datastore together.

FIG. 5B provides an illustration of an exemplary image of a processed resource distribution instrument 350, in accordance with one embodiment of the present invention. The resource distribution instrument illustrated in FIG. 5B is a check. However, one will appreciate that any financial record, financial document, payment instrument, or the like may be provided.

The image of resource distribution instrument illustrated in FIG. 5B includes the processing from an image read program identifying the attributes. Each attribute is identified and a box is presented highlighting the attribute. These attributes may comprise contact information, the payee, the memo description, the account number, routing number associated with the appropriate user or customer account, the date, the resource distribution instrument number, the amount of the resource distribution instrument, the signature, or the like.

As illustrated, the arrows illustrate a distance between the various attributes. In this example, the system has flagged this resource distribution instrument as having attribute anomaly. The system may overlay or highlight the attributes that are not symmetrical and provide the arrow for subsequent exception processing.

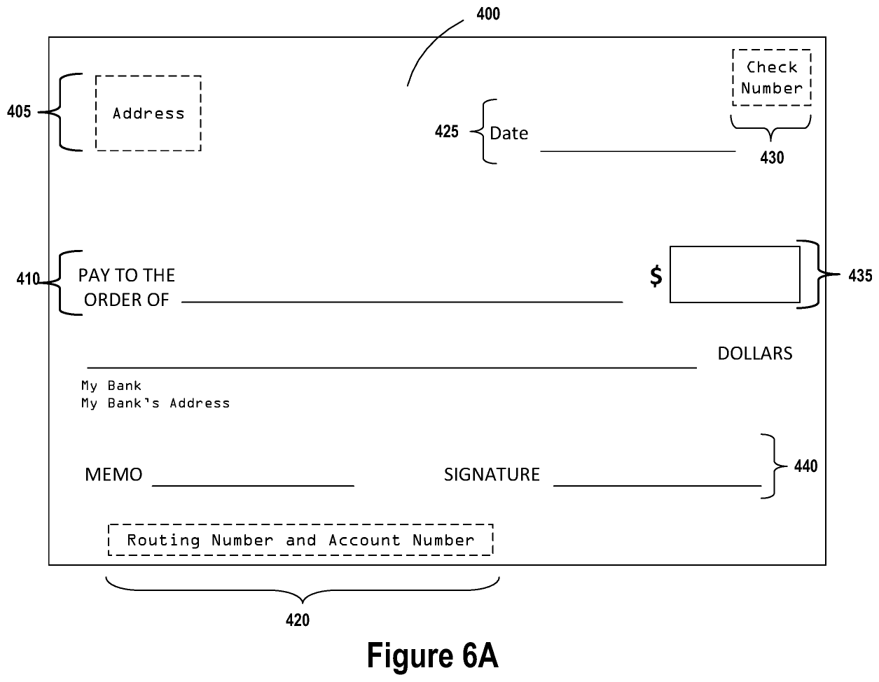

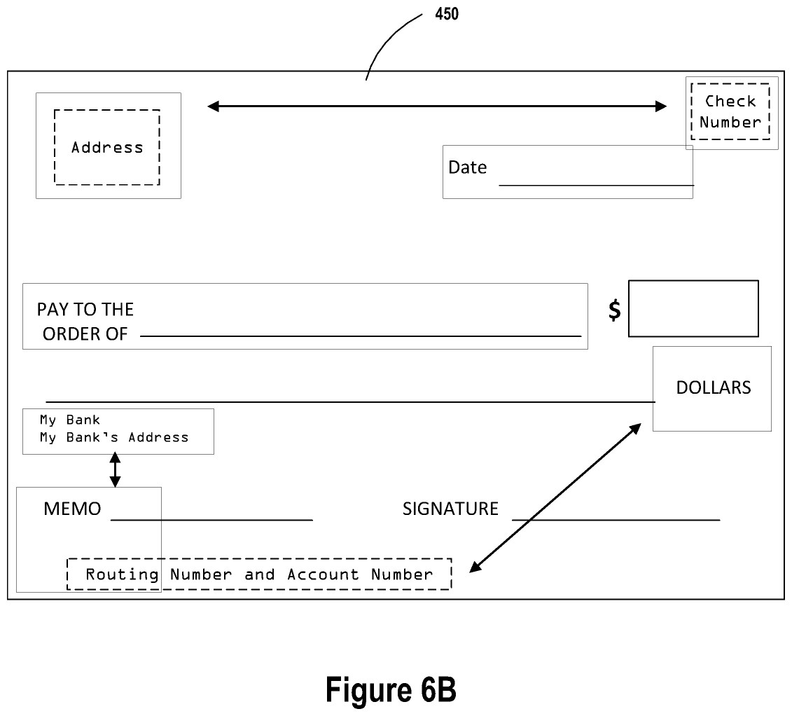

FIG. 6A illustrates an exemplary image of an alternative resource distribution instrument 400, in accordance with one embodiment of the present invention. Again, the financial record illustrated in FIG. 6A is a resource distribution instrument. However, one will appreciate that any financial record, financial document, payment instruments, or the like may be provided.

In the illustrated embodiment, the resource distribution instrument template 400 corresponds to the entire front portion of a resource distribution instrument, but it will be understood that the resource distribution instrument 400 may also correspond to individual pieces of resource distribution instrument information, portions of a resource distribution instrument, or the like. The resource distribution instrument template, in some embodiments, includes the format of certain types of resource distribution instruments associated with a bank, a merchant, an account holder, types of resource distribution instruments, style of resource distribution instruments, resource distribution instrument manufacturer, and so forth. By using the resource distribution instrument, the system may “learn” to map the key attributes of the resource distribution instrument for intelligent attribute spatial scanning. In some embodiments, financial records are categorized by template. The resource distribution instrument 400 is only an exemplary template for a financial record, and other resource distribution instrument or other financial record may be utilized to categorize resource distribution instruments or other financial records. The resource distribution instrument template 400 can be used in the OCR processes, image overlay techniques, and the like.

The resource distribution instrument 400 comprises resource distribution instrument information, wherein the resource distribution instrument information includes, for example, a contact information field 405, a payee line field 410, a memo description field 415, an account number and routing number field 420 associated with the appropriate user or customer account, a date line field 425, a resource distribution instrument number field 430, an amount box field 435, a signature line field 440, or the like.

FIG. 6B illustrates an exemplary template of a financial record 400, in accordance with one embodiment of the present invention. Again, the financial record illustrated in FIG. 6B is a resource distribution instrument. However, one will appreciate that any financial record, financial document, payment instruments, or the like may be provided.

The image of resource distribution instrument illustrated in FIG. 6B includes the processing from an image read program identifying the attributes. Each attribute is identified and a box is presented highlighting the attribute. These attributes may comprise contact information, the payee, the memo description, the account number, routing number associated with the appropriate user or customer account, the date, the resource distribution instrument number, the amount of the resource distribution instrument, the signature, or the like.

As illustrated, the arrows illustrate a distance between the various attributes. In this example, the system has flagged this resource distribution instrument as having attribute anomaly. The system may overlay or highlight the attributes that are not symmetrical and provide the arrow for subsequent exception processing.

In some embodiments, the system may receive images of resource distribution instruments or negotiable instruments from one or more sources. The resource distribution instruments may be received from within an entity, from other financial institutions, or the like. In some instances these resource distribution instruments may be misappropriated resource distribution instruments. The misappropriated resource distribution instruments may appear almost the same as legitimate resource distribution instruments and typically successfully pass through initial resource distribution instrument processing. Once the misappropriated resource distribution instrument is initially processed, the resource amount associated with the instrument is credited in the user's account. However, eventually in the processing the misappropriated resource distribution instrument gets identified as misappropriated, then the credited amount of resources must be removed from the user's account. Not being able to identify this misappropriation causes delay, unnecessary resource distributions, and entity loss of revenue.

In some embodiments, the invention provides an image read program that divides a received resource distribution instrument into different sections and reads the various attributes like date, pay to the order of, resource distribution instrument number, security icon, amount, and the like and the attributes actual position within the resource distribution instrument. The system may read these attributes and the relative position of these attributes to establish a symmetry in the resource distribution instrument image. The symmetry data is processed via machine learning algorithms to cluster out areas in the resource distribution instrument that are suspicious based on the symmetry evaluation. The system may continue to process the data and provide results to prevent the processing of the misappropriated resource distribution instrument prior to distribution.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for intelligent attribute spatial scanning, the system comprising:
a memory device with computer-readable program code stored thereon;
a communication device;
a processing device operatively coupled to the memory device and the communication device, wherein the processing device is configured to execute the computer-readable program code to:
receive an image of a resource distribution instrument;
identify and divide segments of the image of the resource distribution instrument, wherein the segments are divided by attributes on the resource distribution instrument;
program resource distribution instrument attribute data for comparison analysis;
perform comparison analysis via machine learning application processing, wherein the comparison analysis compares a symmetry of the resource distribution instrument attributes to a resource distribution instrument standard;
flag resource distribution instrument comprising a symmetrical anomaly;
route the resource distribution instrument for exception processing within flagged information associated with the resource distribution instrument; and
provide a feedback loop to the machine learning application for result identification of all resource distribution instruments.

2. The system of claim 1, further comprising allowing for real-time resource transfer upon indication on an authentic resource distribution instrument upon a symmetry match between the resource distribution instrument and the resource distribution instrument standard.

3. The system of claim 1, wherein performing comparison analysis further comprises identifying locations of the attributes compared to a standard via an overlay, wherein the locations of the attributes and a distance between the attributes is compared.

4. The system of claim 1, wherein the resource distribution instrument standard further comprises a standard for a location for each attribute and a standard distance between each attribute.

5. The system of claim 1, wherein the attributes of the resource distribution instrument further comprises elements on the resource distribution instruments that are physically printed on the resource distribution instrument.

6. The system of claim 1, wherein receiving an image of a resource distribution instrument further comprising performing optical character recognition on a physical resource distribution instrument to generate the image of the resource distribution instrument.

7. The system of claim 1, wherein the resource distribution instrument comprises a check for a transfer of resources from one user to a second user.

8. A computer program product for intelligent attribute spatial scanning, the computer program product comprising at least one non-transitory computer-readable medium having computer-readable program code portions embodied therein, the computer-readable program code portions comprising:
an executable portion configured for receiving an image of a resource distribution instrument;
an executable portion configured for identifying and dividing segments of the image of the resource distribution instrument, wherein the segments are divided by attributes on the resource distribution instrument;
an executable portion configured for programming resource distribution instrument attribute data for comparison analysis;
an executable portion configured for performing comparison analysis via machine learning application processing, wherein the comparison analysis compares a symmetry of the resource distribution instrument attributes to a resource distribution instrument standard;
an executable portion configured for flagging resource distribution instrument comprising a symmetrical anomaly;
an executable portion configured for routing the resource distribution instrument for exception processing within flagged information associated with the resource distribution instrument; and
an executable portion configured for providing a feedback loop to the machine learning application for result identification of all resource distribution instruments.

9. The computer program product of claim 8, further comprising an executable portion configured for allowing for real-time resource transfer upon indication on an authentic resource distribution instrument upon a symmetry match between the resource distribution instrument and the resource distribution instrument standard.

10. The computer program product of claim 8, wherein performing comparison analysis further comprises identifying locations of the attributes compared to a standard via an overlay, wherein the locations of the attributes and a distance between the attributes is compared.

11. The computer program product of claim 8, wherein the resource distribution instrument standard further comprises a standard for a location for each attribute and a standard distance between each attribute.

12. The computer program product of claim 8, wherein the attributes of the resource distribution instrument further comprises elements on the resource distribution instruments that are physically printed on the resource distribution instrument.

13. The computer program product of claim 8, wherein receiving an image of a resource distribution instrument further comprising performing optical character recognition on a physical resource distribution instrument to generate the image of the resource distribution instrument.

14. The computer program product of claim 8, wherein the resource distribution instrument comprises a check for a transfer of resources from one user to a second user.

15. A computer-implemented method for intelligent attribute spatial scanning, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving an image of a resource distribution instrument;
identifying and dividing segments of the image of the resource distribution instrument, wherein the segments are divided by attributes on the resource distribution instrument;
programming resource distribution instrument attribute data for comparison analysis;
performing comparison analysis via machine learning application processing, wherein the comparison analysis compares a symmetry of the resource distribution instrument attributes to a resource distribution instrument standard;
flagging resource distribution instrument comprising a symmetrical anomaly;
routing the resource distribution instrument for exception processing within flagged information associated with the resource distribution instrument; and
providing a feedback loop to the machine learning application for result identification of all resource distribution instruments.

16. The computer-implemented method of claim 15, further comprising allowing for real-time resource transfer upon indication on an authentic resource distribution instrument upon a symmetry match between the resource distribution instrument and the resource distribution instrument standard.

17. The computer-implemented method of claim 15, wherein performing comparison analysis further comprises identifying locations of the attributes compared to a standard via an overlay, wherein the locations of the attributes and a distance between the attributes is compared.

18. The computer-implemented method of claim 15, wherein the resource distribution instrument standard further comprises a standard for a location for each attribute and a standard distance between each attribute.

19. The computer-implemented method of claim 15, wherein the attributes of the resource distribution instrument further comprises elements on the resource distribution instruments that are physically printed on the resource distribution instrument.

20. The computer-implemented method of claim 15, wherein receiving an image of a resource distribution instrument further comprising performing optical character recognition on a physical resource distribution instrument to generate the image of the resource distribution instrument.
